(19) United States
(12) Patent Application Publication
(10) Pub. No.: US 2017/0178164 A1
(43) Pub. Date: Jun. 22, 2017

(54) Systems and Methods for Use in Processing Transaction Data

(71) Applicant: MASTERCARD INTERNATIONAL INCORPORATED, Purchase, NY (US)

(72) Inventors: Debashis Ghosh, Charlotte, NC (US); Manash Bhattacharjee, Jersey City, NJ (US); Sanket Rajendra Nerkar, Gurgaon (IN); Ashutosh Sharan, Gurgaon (IN); Avyaktanand Tiwary, Gurgaon (IN); Randall K. Shuken, Westport, CT (US)

(21) Appl. No.: 14/974,783

(22) Filed: Dec. 18, 2015

(51) Int. Cl. G06Q 30/02

(52) U.S. Cl. CPC G06Q 30/0204

(57) ABSTRACT

Systems and methods are provided for determining early-adopter payment accounts. One exemplary method generally includes accessing, by a computing device, product data for at least one target product including a product launch date for the at least one target product; accessing transaction data representative of multiple transactions to payment accounts; identifying, by a computing device, at least one of the multiple transactions as involving a purchase of the at least one target product; determining, by the computing device, an interval between the purchase of the at least one target product and the product launch date for the at least one target product; and appending, by the computing device, the payment account associated with the purchase of the at least one target product to an early-adopter segment based on the determined interval satisfying an early-adopter threshold.

### FIELD

The present disclosure generally relates to systems and methods for use in processing transaction data. More particularly, the present disclosure relates to systems and methods for use in identifying payment accounts having purchase transactions for new products, and appending the payment accounts to particular segments (e.g., early-adopter segments, follower segments, late-buyer segments, etc.) based on intervals between the identified purchase transactions and launch dates of the new products.

### BACKGROUND

This section provides background information related to the present disclosure which is not necessarily prior art.

Merchants are known to offer products (e.g., goods and/or services) for sale to consumers. The merchants, from time to time, launch new products for sale. Often, the newly launched products are accompanied by advertising campaigns, designed to encourage consumers to purchase the products. The campaigns are known to be directed to consumers in certain geographic regions, or even consumers that have previously purchased products with the merchants.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in identifying and segmenting payment accounts, based on prior product purchases associated with the payment accounts;

FIG. 2 is a block diagram of a computing device, that may be used in the exemplary system of FIG. 1; and

FIG. 3 is an exemplary method for identifying and segmenting payment accounts, suitable for use with the system of FIG. 1.

Corresponding reference numerals indicate corresponding parts throughout the several views of the drawings.

### DETAILED DESCRIPTION

The description and specific examples included herein are intended for purposes of illustration only and are not intended to limit the scope of the present disclosure.

In connection with launching new products (e.g., new goods and/or services), merchants attempt to advertise to and/or otherwise inform consumers about the products. However, the merchants often have a difficult time identifying particular consumers that are likely to purchase the new products soon after launch of the products (i.e., early-adopter consumers). In addition, some consumers are interested in new products, but do not have access to information about upcoming new product launches. The methods and systems herein enable, for example, the identification of early-adopter payment accounts based on a history of purchase transactions for the accounts, including purchases of new and different products soon after launch dates of the products. Once such payment accounts are identified as associated with early-adopter purchasers, listings of the early-adopter accounts (and/or the associated consumers) can be sent to one or more merchants searching for early-adopter consumers. The merchants can then target product launch communications to the early-adopter consumers with messaging focused around product innovations, new features, or other aspects, etc. to increase early sales and the likelihood of successful product launches. In addition, the identified early-adopter consumers can be permitted to sign up to receive information about to-be-launched products before the products are actually launched. Similarly, the methods and systems herein can also be used to identify other payment accounts, as desired, including, for example, follower payment accounts, late-buyer payment accounts, etc., which may be further targeted with certain advertising, etc.

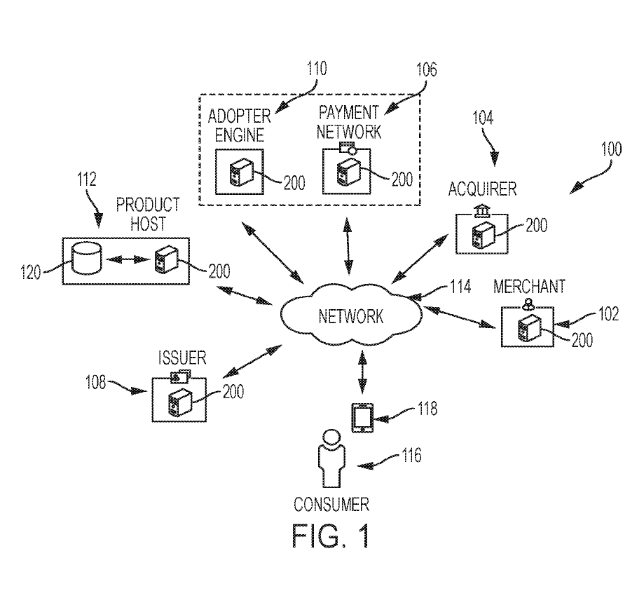

FIG. 1 illustrates an exemplary system 100, in which the one or more aspects of the present disclosure may be implemented. Although the system 100 is presented in one arrangement, other embodiments may include systems arranged otherwise, depending, for example, on manners of accessing product data, processing of payment account transactions, etc.

The system 100 generally includes a merchant 102 (e.g., a merchant that sells one or more target products, etc.), an acquirer 104, a payment network 106, an issuer 108, an adopter engine 110, and a product host (or product database) 112, each coupled to network 114. The network 114 may include, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. For example, network 114 may include multiple different networks, such as a private payment transaction network made accessible by the payment network 106 to the acquirer 104 and the issuer 108 and, separately, the public Internet, which the adopter engine 110, the product host 112, and/or a consumer 116 (via portable communication device 118) may access.

The product host 112 is generally a repository of data for one or more different products, and is organized into a product data structure 120. The data often includes all products, or at least some products, which are offered for sale by one or more merchants (including merchant 102) or other entities, e.g., product distributors, manufacturers, etc. The data structure 120 includes data regarding each product, such as, for example, a launch date for the product, retail pricing, regions (e.g., cities, states, countries, postal codes, etc.) of product manufacture and/or launch, and/or other product-specific data suitable for use as described herein, etc. For purposes of the description herein, the product host 112 is illustrated as a standalone entity, separate from a particular merchant, etc. However, in multiple embodiments, the product host 112 may be incorporated with, or as part of a merchant, such as the merchant 102, or incorporated in, or associated with other parts of the system 100 shown in FIG. 1 (e.g., adopter engine 110), or other parts not shown, etc.

Separately in the system 100, the consumer 116 is associated with one or more payment accounts, through which the consumer 116 completes transactions for products. In particular, the consumer 116 may initiate a transaction by presenting a payment device, such as a credit card, a debit card, a pre-paid card, a payment fob, the communication device 118 with a payment account application included thereon, etc. to the merchant 102 (or to another merchant). The payment device may be presented directly at the merchant 102 in person, or remote from the merchant 102, via network 114, for example.

When the payment device is presented by the consumer 116, the merchant 102, in turn, reads the payment device and/or receives payment account information therefrom and then communicates an authorization request (e.g., including a payment account number and an amount of the purchase, etc.) to the acquirer 104 to determine (in conjunction with the issuer 108) whether the payment account is in good standing and whether there is sufficient credit or funds to complete the transaction. The acquirer 104, in turn, communicates the authorization request with the issuer 108, through the payment network 106, such as, for example, through MasterCard®, VISA®, Discover®, American Express®, etc. If the issuer 108 accepts the transaction, a reply authorizing the transaction is provided back to the merchant 102, thereby permitting the merchant 102 to complete the transaction. The transaction is later cleared and/or settled by and between the merchant 102, the acquirer 104, and the issuer 108. If the issuer 108 declines the transaction, a reply declining the transaction is provided back to the merchant 102, thereby permitting the merchant 102 to stop the transaction.

Transaction data is generated, collected, and stored as part of the above interactions among the merchant 102, the acquirer 104, the payment network 106, the issuer 108, and the consumer 116. The transaction data represents at least a plurality of transactions, e.g., completed transactions, attempted transactions, etc. The transaction data, in this exemplary embodiment, is stored at least by the payment network 106 (e.g., in a data structure associated with the payment network 106, etc.). Additionally, or alternatively, the merchant 102, the acquirer 104, and/or the issuer 108 may store the transaction data, or part thereof, in memory, or transaction data may be transmitted between parts of the system 100, as used or needed. The transaction data includes, for example, payment account numbers, amounts of the transactions, merchant IDs, merchant names, merchant category codes, dates/times of the transactions, locations (e.g., zip codes) of the transactions, products purchased and related descriptions or identifiers, products refunded, etc. It should be appreciated that more or less information related to transactions, as part of either authorization and/or clearing and/or settling, may be included in transaction data and stored within the system 100, at the merchant 102, the acquirer 104, the payment network 106, and/or the issuer 108. Further, transaction data unrelated to a payment account may be collected by a variety of techniques, and similarly stored within the system 100.

In various exemplary embodiments, consumers (e.g., consumer 116, etc.) involved in the different transactions herein are prompted to agree to legal terms associated with their payment accounts, for example, during enrollment in their accounts, etc. In so doing, the consumers may voluntarily agree, for example, to allow merchants, issuers of the payment accounts, payment networks, etc., to use data collected during enrollment and/or collected in connection with processing the transactions, subsequently for one or more of the different purposes described herein.

While one consumer 116 (and one portable communication device 118) and one merchant 102 are illustrated in FIG. 1, it should be appreciated that any number of consumers (and associated communication devices) and merchants may be a part of the system 100, or a part of systems in other embodiments, consistent with the present disclosure. Likewise, a different number of acquirers, payment networks, issuers, and/or product hosts may be included as desired.

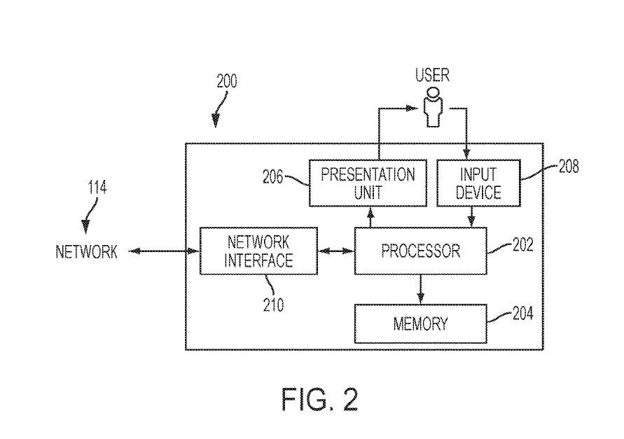

FIG. 2 illustrates an exemplary computing device 200 that can be used in the system 100. The computing device 200 may include, for example, one or more servers, workstations, personal computers, laptops, tablets, smartphones, PDAs, televisions, etc. In addition, the computing device 200 may include a single computing device, or it may include multiple computing devices located in close proximity or distributed over a geographic region, so long as the computing devices are specifically configured to function as described herein. However, the system 100 should not be considered to be limited to the computing device 200, as described below, as different computing devices and/or arrangements of computing devices may be used. In addition, different components and/or arrangements of components may be used in other computing devices.

In the exemplary embodiment of FIG. 1, each of the merchant 102, the acquirer 104, the payment network 106, the issuer 108, the adopter engine 110, and the product host 112 are illustrated as including, or being implemented in, computing device 200, coupled to the network 114. Further, the computing devices 200 associated with these parts of the system 100, for example, may include a single computing device, or multiple computing devices located in close proximity or distributed over a geographic region (again, so long as the computing devices are specifically configured to function as described herein). In addition, the portable communication device 118, associated with consumer 116, can also be considered a computing device consistent with computing device 200 for purposes of the description herein.

Referring to FIG. 2, the exemplary computing device 200 includes a processor 202 and a memory 204 coupled to the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic circuit (PLC), a gate array, and/or any other circuit or processor capable of the functions described herein.

The memory 204, as described herein, is one or more devices that permit data, instructions, etc. to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, product data, transaction data, product names, product merchant names, product launch dates, product categories, product launch zip codes, product prices, list(s) of early-adopter segment payment accounts, list(s) of follower segment payment accounts, list(s) of late-buyer payment accounts, to-be-launched products and related data, and/or other types of data suitable for use as described herein. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. Such instructions often improve the efficiencies and/or performance of the processor 202 that is identifying/determining early-adopter accounts, follower accounts, late-buyer accounts, etc. It should be appreciated that the memory 204 may include a variety of different memories, each implemented in one or more of the functions or processes described herein.

In the exemplary embodiment, the computing device 200 includes a presentation unit 206 that is coupled to the processor 202 (however, it should be appreciated that the computing device 200 could include output devices other than the presentation unit 206, etc.). The presentation unit 206 outputs information (e.g., early-adopter accounts, etc.), either visually or audibly to a user of the computing device 200, for example, the consumer 116, etc. It should be further appreciated that various interfaces (e.g., application interfaces, webpages, etc.) may be displayed at computing device 200, and in particular at presentation unit 206, to display information, such as, for example, to-be-launched products, early-adopter accounts, follower accounts, late-buyer accounts, target products, product launch dates, etc. The presentation unit 206 may include, without limitation, a liquid crystal display (LCD), a light-emitting diode (LED) display, an organic LED (OLED) display, an “electronic ink” display, speakers, etc. In some embodiments, presentation unit 206 includes multiple devices.

The computing device 200 also includes an input device 208 that receives inputs from the user of the computing device 200 (i.e., user inputs) such as, for example, new product selections, etc. The input device 208 is coupled to the processor 202 and may include, for example, a keyboard, a pointing device, a mouse, a stylus, a touch sensitive panel (e.g., a touch pad or a touch screen, etc.), another computing device, and/or an audio input device. Further, in various exemplary embodiments, a touch screen, such as that included in a tablet, a smartphone, or similar device, behaves as both a presentation unit and an input device.

In addition, the illustrated computing device 200 also includes a network interface 210 coupled to the processor 202 and the memory 204. The network interface 210 may include, without limitation, a wired network adapter, a wireless network adapter, a mobile network adapter, or other device capable of communicating to one or more different networks, including the network 114. Further, in some exemplary embodiments, the computing device 200 includes the processor 202 and one or more network interfaces incorporated into or with the processor 202.

Referring again to FIG. 1, the adopter engine 110 is illustrated as a standalone entity, separate from the merchant 102 and the payment network 106. However, the adopter engine 110 may be associated with the payment network 106 in some implementations, as indicated by the dotted lines in FIG. 1. In addition, it should be appreciated that in other embodiments the adopter engine 110 may be incorporated in, or associated with, the merchant 102, the issuer 108, or another entity/part shown or not shown in FIG. 1, etc. Further, the adopter engine 110, while separate, may be linked to any of the entities/parts in system 100, for example, as an application program interface (API).

The adopter engine 110 of the system 100 is configured, often by computer-executable instructions, to perform one or more of the operations described herein. In general, for example, the adopter engine 110 is configured to identify payment accounts having purchase transactions for new products, and append the payment accounts to particular segments (e.g., early-adopter segments, follower segments, late-buyer segments, etc.) based on intervals between the identified purchase transactions and launch dates of the new products. The adopter engine 110 is also configured to transmit lists of one or more of the segments, and the payment accounts included in the segments to merchants associated with the adopter engine 110 so that the payment accounts are available to the merchants for subsequent use. In addition, the adopter engine 110 is also configured to transmit lists of to-be-launched products to consumers (such as the consumer 116, via his/her portable communication device 118) so that the lists of to-be-launched products are available to the consumer 116, for example, for subsequent use. Generally, the adopter engine 110 is remote from (i.e., geographically spaced apart from) the merchants and/or consumers to whom the various lists may be transmitted. As such, the lists as published by the adopter engine 110, and viewed by the merchants and/or the consumers at corresponding computing devices 200, for example, occur via one or more networks, such as network 114.

The various payment account segments, which are defined by the adopter engine 110, may include payment accounts that belong to early-adopter segments, follower segments, late-buyer segments, or any other suitable segments. The different segments may be based on timing of purchases of particular target products, through the payment accounts, relative to launch dates of the products. For example, payment accounts with purchases of target products shortly after launch dates of the target products may be considered early-adopter accounts and may be part of an early-adopter segment; payment accounts with purchases of target products during an intermediate time period after their launch dates may be considered follower accounts and may be part of a follower segment; and payment accounts with purchases of target products during a longer period after launch dates of the target products may be considered late-buyer accounts and may be part of a late-buyer segment; etc.

In operation, the adopter engine 110 is configured to access target products (and associated product data), either available to the public from merchants (such as the merchant 102) or manufacturers, or through exchanges such as the product host 112, etc. The adapter engine 110 is configured to also access transaction data, for example, from the payment network 106, at one or more regular or irregular intervals (e.g., periodically, and/or every 30 days, 60 days, etc.). The adopter engine 110 may be further configured to access only transaction data not accessed below (potentially to avoid double counting certain transactions), or may be configured to access all available transaction data, as indicated below, for one or more payment accounts (often directed to a particular merchant and/or category, etc.).

With regard to a target product available from the merchant 102, for example, the adopter engine 110 is configured to then use the accessed data to identify (or classify) payment accounts used to purchase the target product. In connection therewith, the adopter engine 110 is configured to initially identify transactions, from the transaction data, that involve purchases of the target product, for example (and without limitation), based on, for example, the transactions involving the merchant 102 and purchase prices that are similar to the price of the target product sold by the merchant 102. The adopter engine 110 is configured to then determine an interval between the identified purchases of the target product and the product launch date of the target product. The interval may be based on a time period such as, for example, a number of days, etc. In some implementations, after determining the interval, the adopter engine 110 may be configured to assign a score to each of the identified purchases (e.g., when multiple purchases of a target product are identified for a given payment account, etc.) based on the interval. As a result, the adopter engine 110 may determine if the identified purchases of the target product were made soon after launch (i.e., by an early adopter), or later in the life cycle of the product (e.g., by a follower, by a late buyer, etc.), and subsequently identify the corresponding payment accounts as early-adopter accounts, follower accounts, or late-buyer accounts.

Once the payment accounts used to purchase the target product from the merchant 102 are identified, the adopter engine 110 is configured to append the payment accounts to an appropriate segment (e.g., an early-adopter segment, a follower segment, a late-buyer segment, etc.), and to store the segment in memory 204 of the computing device 200 associated with the adopter engine 110, or in other memories. The adopter engine 110 is configured to then publish lists of the payment accounts in the different segments to various entities, including, for example, the merchant 102, etc. As can be appreciated, a list of the payment accounts in the early-adopter segment (or other segments) may provide a valuable resource to the merchant 102 by which the merchant 102 can target (or not target) marketing, advertising, incentives, etc., for existing new products and future products to increase the likelihood of purchase by the identified early adopters. In addition, the merchant 102 can determine whether particular consumers are interested in purchasing a new product as soon as it is available (i.e., to become early adopters of the new products), or not.

Further, the adopter engine 110 may be configured to publish lists of to-be-launched products, as gathered from the accessed product data (e.g., from the product host 112, etc.), to consumers associated with payment accounts identified to particular segments, for example, the early-adopter segment. As can be appreciated, consumers associated with early-adopter accounts may be interested in learning about to-be-launched products as early as possible, and purchasing the products as soon as they are available (i.e., to become early adopters of the products).

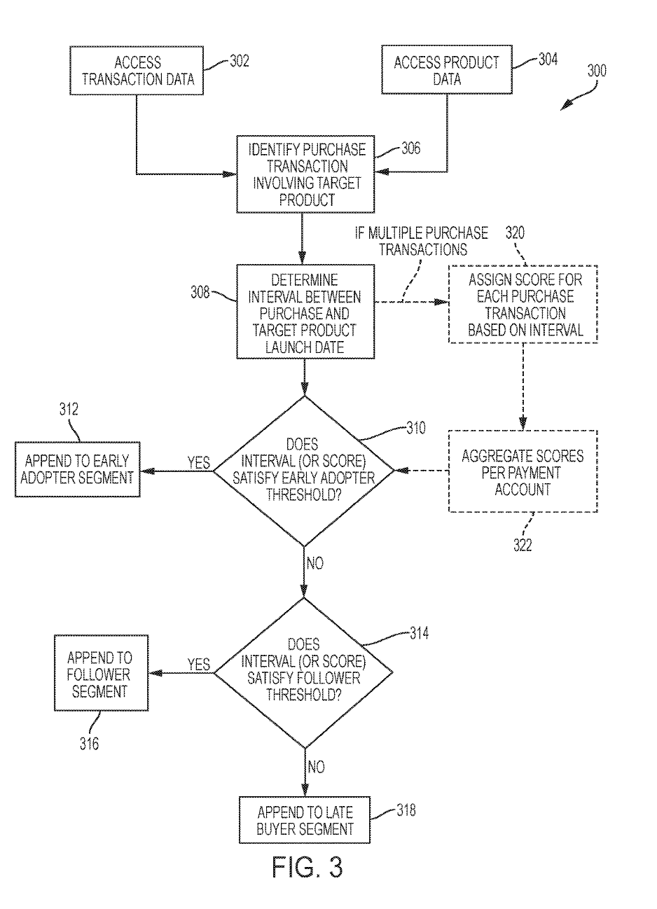

FIG. 3 illustrates an exemplary method 300 for identifying payment accounts having purchase transactions for new (or target) products, and appending the payment accounts to particular segments (e.g., early-adopter segments, follower segments, late-buyer segments, etc.) based on intervals between the identified purchase transactions and launch dates of the new products. The exemplary method 300 is described herein as implemented in the adopter engine 110 of the system 100. However, the method 300 is not limited to the adopter engine 110, or for that matter to the system 100, and, as such, may be implemented in other parts of the system 100 or in other systems. Further, for purposes of illustration, the exemplary method 300 is described herein with reference to the computing device 200. But the methods herein should not be understood to be limited to the exemplary system 100 or the exemplary computing device 200, and the systems and the computing devices herein should not be understood to be limited to the exemplary method 300.

In the method 300, the adopter engine 110 initially accesses transaction data, at 302, from the payment network 106 (via network 114) for various payment accounts, as desired. Once accessed, the adopter engine 110 may store particular data in memory 204. The adopter engine 110 may access all available transaction data for all available payment accounts from the payment network 106. Or, the adopter engine 110 may access less than all available transaction data, for example, all transaction data for one or more specified periods, all transaction data for one or more specified payment accounts (e.g., transaction amounts, etc.), or combinations thereof, etc. In addition, the adopter engine 110 may access transaction data in a continuous manner, or at particular intervals, or upon request, so that any transaction data already accessed and/or stored in memory 204 of the adopter engine's computing device 200 may be updated as appropriate. Further, and as described above, the accessed transaction data may include any suitable data representative of transactions, between consumers and merchants, to payment accounts associated with the consumers.

At about the same time (or earlier or later), the adopter engine 110 also accesses product data, at 304, for various target products either available to the public from merchants (such as the merchant 102) or manufacturers, or through exchanges such as the product host 112, etc. For example, the product host 112 may include product data for various target products from one or more search engines, manufacturers, merchants, marketing entities, social media networks, etc. Once accessed through the product host 112, for example, the adopter engine 110 may store particular data in memory 204. The product data may include any suitable information relating to the target products such as, for example, launch dates for each of the corresponding target products, merchants associated with each of the target products, categories associated with each of the target products and/or corresponding merchants (e.g., based on product category tags, etc.), etc. In addition, the adopter engine 110 may access product data in a continuous manner, or at particular intervals, or upon request, so that any product data already stored in memory 204 of the adopter engine's computing device 200 may be updated as appropriate.

As used herein, target products generally include products that are new in the marketplace and different from existing products, although any product from any merchant could be a target product. As an example, products that involve new technologies, address new consumer trends, etc., may be target products, because consumers, such as early adopters, that purchase such products early, i.e., close to their launch dates, may be more likely to adopt, early, new and different products from the same merchants or other merchants in the future. Example target products may include, without limitation, new cars, new electronics (e.g., tablets, smartphones, audio devices, etc.), new food items, new sporting and/or exercise products addressing current trends, tickets and other products related to new musicians and shows, environmentally friendly products, etc. In the method 300, target products may be identified for review/analysis as desired, for example, by the adopter engine 110 (e.g., automatically, by an administrator, etc.), by the product host 112, by merchants associated with the target products and provided to the adopter engine 110 (or to the product host 112), by consumers upon inquiry from the adopter engine 110, etc. In addition, target products, as used herein, may be from the same or different product categories, the same or different merchants, etc.

Once the desired transaction data and product data is accessed, the adopter engine 110 identifies, at 306, purchase transactions in the transaction data that involve a selected target product (or that involve multiple different target products). Such identification can be based on various different parameters, for example (and without limitation), a product name for a target product, a merchant name for a merchant selling the target product, a category of the target product and/or related merchant, a price of the target product, etc. In the illustrated embodiment, the adopter engine 110 identifies purchase transactions for a target product based on a merchant name and a product price (e.g., via a keyword search, etc.).

As an example, the adopter engine 110 may identify all transactions that occur at a particular merchant associated with a selected target product for an amount that is greater than or equal to a price of the target product. In so doing, the adopter engine 110 identifies all transactions that involve a purchase of the target product, but may also identify some transactions that do not include the target product (i.e., for items that are more expensive than the target product, or involve a total sale amount that adds up to more than the price of the target product). However, it is contemplated that when such identification operations are used for a target product that is generally more expensive (e.g., a new car, etc.) or that is one of the most expensive products offered by the merchant, the number of identified transactions that do not include the target product will be minimal.

As another example, the adopter engine 110 may identify transactions that include a purchase price that is the same as (e.g., a suggested retail price, a price indicated by the merchant 102, for example), or substantially the same as (e.g., accounting for increases due to sales tax (or other applicable taxes), variations in price by merchant and/or geographic region (e.g., ±about 3%, ±about 5%, etc.), etc.) a price of a selected target product, or that is a multiple of the price (e.g., to account for transactions where more than one of the target product is purchased, such as for food items, smaller electronic items, etc.).

As previously described, the adopter engine 110 may identify the purchase transactions at 306 in any suitable order or sequence. For example, the adopter engine 110 may first access product data for a selected target product at 304, and then access transaction data at 302 and search for transactions involving the target product. Or, after accessing the product data for the selected target product at 304, the adopter engine 110 may access transaction data at 302 and select a subset of the transactions that is associated with a merchant providing the target product, and then search for transactions involving the target product. Alternatively, the adopter engine 110 may first access transaction data at 302 for a desired interval, and then access product data for a selected target product at 304 and search in the transaction data for transactions involving the target product. As can be appreciated, any number of various search strategies may be used to search through transaction data and product data to identify one or more transactions as involving a purchase of a target product.

In some embodiments, the adopter engine 110 may filter (or limit) transaction data to a specific product category (e.g., sporting goods, automobiles, etc.). This may be done in connection with accessing the product data at 304, or as part of identifying the purchase transactions at 306, or as a separate operation. Regardless of when performed, the adopter engine 110 then searches for transactions, in the filtered transaction data, for purchase transactions for a specified target product. The identified transactions then involve purchases only within the specific product category, which may provide more relevant results (e.g., for use in identifying early-adopter payment accounts, etc.). For example, it is contemplated that early purchasers of new electronic items may be more likely to purchase other new electronic items as compared to new food items.

With continued reference to FIG. 3, for a given identified purchase transaction (e.g., when a single transaction is identified at 306, etc.), the adopter engine 110 next determines, at 308, an interval between the date the target product was purchased and a product launch date for the target product. The interval generally includes a measurement of time, for example, in hours, days, weeks, months, etc.

The adopter engine 110 then compares the determined interval to an early-adopter threshold, at 310. The early-adopter threshold may include any suitable value indicative that the purchase transaction for the selected target product is made at an early time, relative to a launch of the product. For example, the early-adopter threshold may be one day, three days, two weeks, one month, three months, etc. In addition, the early-adopter threshold may generally be the same for all target products evaluated by the adopter engine 110, or it may be different for different target products and/or different target product categories. For example, target products that are generally less expensive or that have large marketing campaigns may be more known to consumers prior to launch and, thus, may have shorter earlier adopter thresholds (e.g., one week, two weeks, etc.). In contrast, target products that are generally more expensive, or potentially less expensive, and that are less well known to consumers prior to launch, may have longer earlier adopter thresholds (e.g., two months, three months, etc.). In some embodiments, the adopter engine 110, or a user associated therewith, may use one or more principles of diminishing returns to identify the early adopter threshold (or other thresholds herein) after the fact, per target product or category, based on one or more trends defined by historical sales for a target product following launch of the target product.

When the determined interval satisfies the early-adopter threshold (e.g., is less than the early-adopter threshold, etc.), the adopter engine 110 appends the payment account, through which the identified purchase transaction was made, to an early-adopter segment, at 312. The early-adopter segment may include any segment, list, group, etc. of payment accounts that are identified, by the adopter engine 110, as having purchase transactions for target products shortly after launch dates for the products (i.e., within the early-adopter threshold of the product launch dates). The adopter engine 110 may store multiple early-adopter segments in memory 204 (e.g., for different target products, for different product categories, etc.), along with data for the corresponding payment accounts included therein, with each of the segments differentiated, for example, based on one or more parameters including (without limitation) target product categories, target product prices, intervals for early adoption, etc.

However, when the determined interval does not satisfy the early-adopter threshold (e.g., is equal to or greater than the early-adopter threshold, etc.), the adopter engine 110 further compares the interval to a follower threshold, at 314. The follower threshold is generally longer than the early-adopter threshold, and may be based on a multiple or a proportion of, etc., the early-adopter threshold, or not. For example, a target product with a one month early-adopter threshold may have a follower threshold of four months, or a target product with a two-week early-adopter threshold may have a follower threshold of two months. Moreover, the follower threshold may generally be the same for all target products, or it may be different for different target products and/or different target product categories.

At 316 in the method 300, when the interval determined at 308 satisfies the follower threshold (e.g., is less than the follower threshold, etc.), the adopter engine 110 appends the payment account, through which the identified purchase transaction was made, to a follower segment. This generally indicates that the payment account, and particularly the consumer associated with the payment account, is not necessarily an early adopter, but prefers to follow trends once they become more established. The adopter engine 110 may store multiple follower segments in memory 204 (e.g., for different target products, for different product categories, etc.), along with data for the corresponding payment accounts included therein, with each of the segments differentiated, for example, based on one or more parameters including (without limitation) target product categories, target product prices, follower thresholds, etc.

Conversely, when the interval determined at 308 does not satisfies the follower threshold (e.g., is equal to or greater than the follower threshold, etc.), the adopter engine 110 appends the payment account, through which the identified purchase transaction was made, to a late-buyer segment, at 318. This segment may indicate that the consumer associated with the appended payment account is not necessarily an early adopter or follower, but still prefers to purchase products as needed, or as they become commonplace, etc. As should be apparent, other embodiments may include more or less segments, different thresholds for each segment, etc.

Further, apart from the timing of the purchase of a target product, the adopter engine 110 may rely (at least in part) on the merchant involved in the transaction for appending the corresponding payment account to a particular segment. For example, when the adopter engine 110 identifies a transaction to a payment account involving a particular merchant (e.g., Kickstarter, etc.) that is known to be a platform (e.g., a crowdsourced platform, etc.) for new products, the payment account may automatically be identified as an early adopter payment account. Here, one or more thresholds may be omitted from the determination of whether or not to append the payment account to a particular segment. Instead, upon identifying a purchase transaction for the payment account from the particular merchant (e.g., at operation 306 in method 300, etc.), the adopter engine 110 may simply append the payment account to an early adopter segment (e.g., at operation 312 in method 300, etc.).

Similarly, the adopter engine 110 may limit the placement of the payment account to either the early adopter segment or the follower segment based on the transaction being at the particular merchant (i.e., the payment account would not appended to the late adopter segment in this scenario). Or, alternatively, the one or more thresholds may be used in combination with the particular type of merchant (or in combination with the particular merchant) in determining whether or not to append the payment account to a particular segment. For example, a threshold (e.g., as employed at operations 310 and/or 314 in method 300, etc.) may be generally longer (e.g., 90 days, etc.) for a merchant known to be a platform for new products, as compared to a threshold (e.g., 30 days, etc.) for other merchants.

With further reference to FIG. 3, additionally, or alternatively, the adopter engine 110 may employ certain scoring to determine in which segment a payment account should be assigned. For example, when the adopter engine 110 identifies multiple purchase transactions for target products, at 306, for a single payment account, the adopter engine 110 may, optionally (as indicated by the dotted lines), generate an overall score for the payment account at 320-322, taking into account each of the multiple purchases of the target products (and particularly, the determined intervals therefor at 308). The score then provides an indicator of how soon the multiple purchases were made after the launch of the respective target product. The overall score can then be used to append (or not) the payment account to one of the early-adopter segment, the follower segment, and the late-buyer segment at 310-318.

In particular in method 300, after determining an interval between the dates of the multiple purchase transactions for the target product and a product launch date for the target product (s), at 308 for the multiple purchase transactions, the adopter engine 110 assigns a score to each purchase transaction, at 320, based on the determined interval for each purchase transaction. The particular scores may further be calculated based on a variety of factors including, for example, the growth rate of the number of transactions for the target product within the interval, or within a different or adjacent interval, etc. In one particular example, the number of transactions for the target product is plotted over time, whereby a regression line can then be fitted to the trend in a particular interval and the slope of the regression line is then used to define the score for that interval. It should be appreciated that various other techniques may be employed to derive a score from the number of transactions for the target product over time, for discrete intervals. Next, the scores for each of the purchase transactions are then aggregated, at 322, for the payment account, and used at 310-318 (as a basis of comparison to the various thresholds), as described above, to append (or not) the payment account to one of the early-adopter segment, the follower segment, and the late-buyer segment.

It should be appreciated that the scores assigned to each of the multiple purchase transactions for the target product, by the adopter engine 110, may be aggregated at 322 using any suitable formula, etc., including (without limitation) an average of each assigned score, a sum of each assigned score, a weighted average of each assigned score, bins of assigned scores, counts of assigned score ranges, etc. In addition, the adopter engine 110 may aggregate the scores using transaction data and product data, accessed at 302 and 304.

In one example implementation of method 300, an early adopted threshold for a product launch is set at 180 days from the launch of the product. After the product launch, the product is purchased by two consumers, i.e., consumer A and consumer B. Consumer A purchases the product 2 days after the launch date, and accordingly, at 308, the adopter engine 110 determines an interval to be 2 for consumer A. Subsequently, 64 days after the launch date of the product, consumer B purchases the product. The adopter engine 110, then, determines, at 308, that the interval for the purchase by consumer B is 64. And, at 179 days after the launch date of the product, consumer C purchases the product. The adopter engine 110 then determines, at 308, that the interval for the purchase by consumer C is 179. At 320, the adopt engine 110 assigns a score to consumer A of 0.9888 (i.e., (180−2)/180), a score to consumer B of 0.6444 (i.e., (180−64)180), and a score to consumer C of 0.0055 (i.e., (180−179)/180).

The process is repeated for subsequent purchases by consumers A-C of different products, and by other consumers of this and other products. The adopter engine 110 then aggregates, at 322, the scores for each of the consumers A-C (and specifically, for the payment accounts associated with the consumers) (when multiple scores exist for each of the consumers A-C), over a defined interval (e.g., 30 days, 180 day, 1 year, etc.), by, in this example, averaging the scores. The adopter engine 110, in this example, then lists the aggregate scores and corresponding consumers A-C (and other consumers) in descending order, and, identifies the top 20%, 30%, 50%, 66% or 75%, etc. (or some other portion, or the whole of consumers, etc.), thereby applying a second early adopter threshold, at 310. In the above example, when the threshold is the top 75%, consumers A and B are identified, while consumer C is not. (even through each purchased within the original 180 day threshold). More generally, in this example, a first threshold is employed to limit the transaction data for consumers A-C, with the second threshold used, at 310, to append the consumers' payment accounts (for consumers A and B) to the early adopter segment, at 312

Further, in some implementations of the method 300, instead of assigning a score to each of the multiple purchase transactions at 320, the adopter engine 110 may instead average the determined intervals for each of the purchase transactions, sum the determined intervals, sum the total number of purchase transactions involving the target product, etc. and then assign the payment account to the appropriate segment based on the averaged or summed intervals or total transaction count. For example, the payment account may be assigned to the early-adopter segment if the payment account has a total number of target product purchases with determined intervals that are above a threshold count for a particular interval (or multiple particular intervals). Or, the payment account may be assigned to the early-adopter segment when more than three, five, ten, etc. target product purchases are made through the payment account within the early-adopter threshold (e.g., such that a specified number of purchases of the target product are made within a predefined time period, etc.). Other interval count thresholds, etc. may be used in other embodiments for the early-adopter segments, other segments, etc.

Moreover, in certain embodiments, once an early-adopter payment account is identified, back testing may be performed to determine whether the identified payment account has any other early-adopter purchase transactions for target products. The back testing may be used to determine the strength of the early-adopter status of the payment account, derive variables related to the early-adopter status and purchase behavior, etc. For example, early-adopter identification may be supplemented by calculating a social media influencer score tied to a propensity to purchase new products, indicating a particular influence that may have caused the early adopter behavior. Specifically, if the number of transactions for a target product grew after launch and then declined, but then further grew after an influential sponsor endorsed the target product (e.g., a celebrity endorsement, etc.), back testing would permit measuring the delta effect of the influential sponsor, whereby the payment account could be segmented in the absence of the outside influence and/or otherwise designated as a “influenced” early adopter payment account. Numerous different uses of such information may be appreciated by those skilled in the art.

Further, in certain other embodiments, look-alike models may be built for a buyer segment of a target product and overlaid on other payment accounts that do not have transaction data related to the launch of the target product to identify other consumers that may be similar to those currently in the buyer segment. For example, when the new Apple® iPhone® was launched, transaction data for various payment accounts could have been subjected to the systems and methods herein to identify early adopter segments of payment accounts and/or follower segments of payment accounts. Method 300, as described above, may be directed to historical data, thereby segmenting the payment accounts based on the historical data. Then, one or more look-alike models are then created for these segments of payment accounts for one or more subsequent electronic and/or Apple® products, whereby, for example, the gender, age, region, other demographic, or purchasing profile of the payment accounts (and particularly of the consumers associated with the payment accounts) may be used, in addition to the segments described herein, to model other consumers potentially interested in purchasing the subsequent electronic and/or Apple® products.

Referring again to FIG. 3, finally in the method 300, once the payment account has been appended to one of the early-adopter segment, the follower segment, and the late-buyer segment, the adapter engine 110 may generate lists of payment accounts included in each of the segments. The adapter engine 110 may then send the lists to one or more merchants (e.g., to merchant 102, etc.) and/or to one or more consumers (e.g., consumer 116, etc.), as desired.

As an example, a merchant may sign up to receive a list of early-adopter payment accounts so that early buyers can be targeted for product launch communications. In addition, in some examples, the list generated by the adapter engine 110 may be limited to early adopters in one or more specific product categories, which may be related to the type of products provided by the particular merchant receiving the list. The merchant may then use the list to target early buyers for a product launch communication, with messaging focused around product innovations and new product features, etc. As another example, a merchant may sign up to receive a list of follower payment accounts, so that targeted messaging may be sent out to consumers associated with the payment accounts several weeks, etc. after launch of a new product with messages focused around other consumer feedback, reviews, acceptance, etc. of the new product.

As still another example, a consumer associated with an early adopter payment account (or any other payment account) may be offered an option to receive information about to-be-launched products. In this manner, the consumer can stay current on the latest product offerings ahead of their launch so that the consumer can be one of the first to purchase the new products.

In various aspects of the present disclosure, upon segmenting the payment accounts as described herein, marketing communications can be improved across product purchase cycles, whereby consumers are informed of products at one or more paces commensurate with the purchases propensities of the consumers. In addition, surveys, market research, etc. can be conducted to understand new product expectations from the early adopters, the followers, and/or the late buyers, which may help generate new ideas for the development of the new product and create a successful launch of the new product.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following steps: (a) accessing product data for at least one target product; (b) accessing transaction data representative of multiple transactions to payment accounts; (c) identifying at least one of the multiple transactions as involving a purchase of the at least one target product; (d) determining an interval between the purchase of the at least one target product and the product launch date for the at least one target product; (e) appending the payment account associated with the purchase of the at least one target product to an early-adopter segment, when the determined interval satisfies (e.g., is less than, etc.) an early-adopter threshold; (f) defining a list of identified early-adopter accounts included in the early-adopter segment; and/or (g) transmitting the list of early-adopter accounts to one or more merchants.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” “coupled to,” “associated with,” or “included with” another element or layer, it may be directly on, engaged, connected or coupled to, or associated with the other element or layer, or intervening elements or layers may be present. As used herein, the term “and/or” includes any and all combinations of one or more of the associated listed items.

In addition, as used herein, the term product may include a good and/or a service.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature could be termed a second feature without departing from the teachings of the exemplary embodiments.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for processing transaction data associated with one or more merchants, the method comprising:
accessing, by a computing device, product data for at least one target product, the product data including a product launch date for the at least one target product;
accessing, by the computing device, transaction data representative of multiple transactions to payment accounts;
identifying, by the computing device, at least one of the multiple transactions as involving a purchase of the at least one target product;
determining, by the computing device, an interval between the purchase of the at least one target product and the product launch date for the at least one target product; and
appending, by the computing device, the payment account associated with the purchase of the at least one target product to an early-adopter segment, based on the determined interval relative to an early-adopter threshold.

2. The method of claim 1, wherein the product data further includes a sale price for the at least one target product; and
wherein identifying at least one of the multiple transactions as involving a purchase of the at least one target product includes identifying at least one of the multiple transactions as having a purchase amount consistent with the sale price of the at least one target product.

3. The method of claim 2, wherein the purchase amount is consistent with the sale price for the at least one target product when the purchase amount is the same or substantially the same as: the sale price of the at least one target product or a multiple of the sale price of the at least one target product.

4. The method of claim 2, further comprising:
defining, by the computing device, a list of identified early-adopter payment accounts included in the early-adopter segment; and
transmitting, by the computing device, the list of early-adopter payment accounts to one or more merchants.

5. The method of claim 1, further comprising:
identifying, by the computing device, a list of one or more to-be-launched products; and
transmitting, by the computing device, the list to a user associated with each payment account included in the early-adopter segment.

6. The method of claim 1, further comprising, appending, by the computing device, the payment account associated with the purchase of the at least one target product to a follower segment, when the determined interval does not satisfy the early-adopter threshold but does satisfy a follower threshold.

7. The method of claim 6, further comprising, appending, by the computing device, the payment account associated with the purchase of the at least one target product to a late-buyer segment, when the determined interval does not satisfy either the early-adopter threshold or the follower threshold.

8. The method of claim 1, wherein the at least one target product includes a first target product; and
further comprising:
accessing, by the computing device, product data for a second target product, the product data including a product launch date for the second target product;
identifying, by the computing device, at least one of the multiple transactions as involving a purchase of the second target product; and
determining, by the computing device, a second interval between the purchase of the second target product and the product launch date for the second target product;
wherein appending further includes appending, by the computing device, the payment account associated with the purchase of the second target product to the early-adopter segment, when the determined second interval satisfies a different early-adopter threshold.

9. The method of claim 8, wherein the first target product is a product of a first merchant, and the second target product is a product of a second merchant or a product different than the first target product.

10. The method of claim 1, wherein the at least one target product includes a first target product; and
further comprising, for each payment account appended to the early-adopter segment:
accessing, by the computing device, product data for a second target product, the product data including a product launch date for the second target product;
identifying, by the computing device, at least one of the multiple transactions as involving a purchase of the second target product;
determining, by the computing device, a second interval between the purchase of the second target product and the product launch date for the second target product;
calculating, by the computing device, an early-adopter value for each purchase of one of the first and second target products based on the determined interval between said purchase of said target product and the product launch date of said target product; and
aggregating, by the computing device, each early-adopter value to define an early-adopter score for the payment account;
wherein appending the payment account includes appending, by the computing device, the payment account to the early-adopter segment, when the early-adopter score satisfies the early-adopter score threshold.

11. A non-transitory computer readable storage media including computer executable instructions that, when executed by at least one processor, cause the at least one processor to:
access product data for multiple target products and transaction data representative of multiple transactions to payment accounts, the product data including a product launch date for each of the multiple target products;
for each of the transactions involving a purchase of one of the multiple target products, assign a score to the transaction based on an interval between the purchase of the target product and the product launch date for the target product;
aggregate the assigned scores for each of the transactions associated with a same payment account; and
append the payment account to an early-adopter segment, when the aggregated score satisfies an early-adopter threshold.

12. The non-transitory computer readable storage media of claim 11, wherein, for each of the transactions involving a purchase of one of the multiple target products, the interval includes a number of days between the purchase of the target product and the product launch date for the target product.

13. The non-transitory computer readable storage media of claim 11, further including computer executable instructions that, when executed by the at least one processor, cause the at least one processor to:
append the payment account to a follower segment, when the aggregated score does not satisfy the early-adopter threshold but does satisfy a follower threshold; and
append the payment account to a late-buyer segment when the aggregated score does not satisfy either the early-adopter threshold or the follower threshold.

14. The non-transitory computer readable storage media of claim 11, further including computer executable instructions that, when executed by the at least one processor, cause the at least one processor to:
generate a list of payment accounts appended to the early-adopter segment; and
transmit the list to one or more merchants.

15. The non-transitory computer readable storage media of claim 11, further including computer executable instructions that, when executed by the at least one processor, cause the at least one processor to:
identify a list of one or more to-be-launched products; and
transmit the list to a user associated with each payment account appended to the early-adopter segment.

16. A system for processing transaction data associated with one or more merchants, the system comprising:
a memory including transaction data representative of multiple transactions to payment accounts; and
at least one processor coupled to the memory and configured to:
access product data for multiple target products and the transaction data, the product data including a product launch date for each of the multiple target products;
for each payment account, determine, and store in the memory, an interval for each transaction to the payment account that involves a purchase of one of the multiple target products, the interval based on a length of time between the purchase of the target product and the product launch date of the target product; and
append the payment account to an early-adopter segment, when the payment account includes a predefined count of the intervals that are less than a defined early-adopter threshold.

17. The system of claim 16, wherein the at least one processor is further configured to assign a score to each transaction based on the length of the interval; and
wherein the at least one processor is configured to append the payment account to the early-adopter segment, when the payment account includes the predefined count of the intervals, as indicated by the assigned scores, that are less than a defined early-adopter threshold.

18. The system of claim 16, wherein the predefined count is three intervals.

19. The system of claim 16, wherein each of the multiple target products is associated with one of multiple product categories.

20. The system of claim 19, wherein the at least one processor is configured to append the payment account to an early-adopter segment, when the payment account has a predefined count of intervals that are less than the early-adopter threshold for transactions involving purchases of products associated with one of the product categories.
